(19) United States
(12) Patent Application Publication
(10) Pub. No.: US 2020/0209947 A1
(43) Pub. Date: Jul. 2, 2020

(54) INFORMATION PROCESSING SYSTEM WITH A PLURALITY OF PLATFORMS

(71) Applicant: FUJITSU CLIENT COMPUTING LIMITED, Kanagawa (JP)

(72) Inventor: Hiroki Teramoto, Kawasaki (JP)

(73) Assignee: FUJITSU CLIENT COMPUTING LIMITED, Kanagawa (JP)

(21) Appl. No.: 16/697,600

(22) Filed: Nov. 27, 2019

(30) Foreign Application Priority Data
Dec. 28, 2018 (JP) 2018-248325

(51) Int. Cl. G06F 1/3287; G06F 1/28; G06F 1/3237; G06F 1/3228; G06F 13/14; G06F 15/167

(52) U.S. Cl. CPC G06F 1/3287; G06F 1/28; G06F 15/167; G06F 1/3228; G06F 13/14; G06F 1/3237

(57) ABSTRACT

A system includes: a first platform, a second platform, and a relay device including an expansion bus connected to the first and the second platforms. The relay device includes a power supply control microcomputer that outputs, after having been notified that the first platform is to be restarted, a start request to turn on a power supply of the second platform to the second platform, and starts the communication control microcomputer after the communication control microcomputer is shut down. The second platform includes a second processor that performs shutdown processing to turn off the power supply of the second platform in response to reception of a shutdown request for requesting shutting down of the second platform, and performs start processing for starting the second platform in response to reception of the start request from the relay device.

### CROSS-REFERENCE TO RELATED APPLICATIONS

This application is based upon and claims the benefit of priority from Japanese Patent Application No. 2018-248325, filed Dec. 28, 2018, the entire contents of which are incorporated herein by reference.

### FIELD

An embodiment described herein relates generally to a system.

### BACKGROUND

To perform parallel computing using a plurality of processors, techniques have been developed in which, in an information processing system including a host personal computer (PC), the processors, and a relay device having an expansion bus, such as a Peripheral Component Interconnect Express (PCIe), that is connectable to the host PC and the processors, the relay device controls communication between the host PC and the processors through the expansion bus.

The blocks of the host PC, the processors, and the relay device included in the information processing system independently operate, and power supply is also independently controlled for each of the blocks. Accordingly, it is difficult to restart the processors in response to a restart of the host PC, so that only the host PC restarts. Thus, maintainability of the information processing system may be reduced.

SUMMARY

According to one aspect of this disclosure, in general, an information processing system includes a first platform, a second platform, and a relay device including an expansion bus connectable to the first platform and the second platform, wherein the first platform includes a first processor that, after a predetermined condition is met, restarts the first platform, and, before the first platform is restarted, notifies the relay device that the first platform is to be restarted, the relay device includes a communication control microcomputer that controls communication between the first platform and the second platform through the expansion bus; and a power supply control microcomputer that outputs, after having been notified that the first platform is to be restarted, a start request to turn on a power supply of the second platform to the second platform, and starts the communication control microcomputer after the communication control microcomputer is shut down, and the second platform includes a second processor that performs shutdown processing to turn off the power supply of the second platform in response to reception of a shutdown request for requesting shutting down of the second platform, and performs start processing for starting the second platform in response to reception of the start request from the relay device.

### BRIEF DESCRIPTION OF THE DRAWINGS

FIG. 1 is a diagram illustrating an example of an overall configuration of an information processing system according to an embodiment;

FIG. 2 is a diagram illustrating an example of a hardware configuration of the information processing system according to the embodiment;

FIG. 3 is a diagram illustrating an example of a software configuration of platforms of the information processing system according to the embodiment;

FIG. 4 is a diagram for explaining an example of communication processing between the platforms in the information processing system according to the embodiment;

FIG. 5 is a diagram illustrating an example of how any one of the platforms recognizes the other of the platforms in the information processing system according to the embodiment;

FIG. 6 is a diagram illustrating another example of how any one of the platforms recognizes the other of the platforms in the information processing system according to the embodiment;

FIG. 7 is a diagram for explaining an example of a method for data transfer between processors through a relay device in the information processing system according to the embodiment;

FIG. 8 is a block diagram illustrating an example of a functional configuration of the information processing system according to the embodiment;

FIG. 9 is a sequence diagram illustrating an example of a flow of restart processing in the information processing system according to the embodiment; and

FIG. 10 is another sequence diagram illustrating the example of the flow of the restart processing in the information processing system according to the embodiment.

### DETAILED DESCRIPTION

The following describes a system according to an embodiment, using the accompanying drawings.

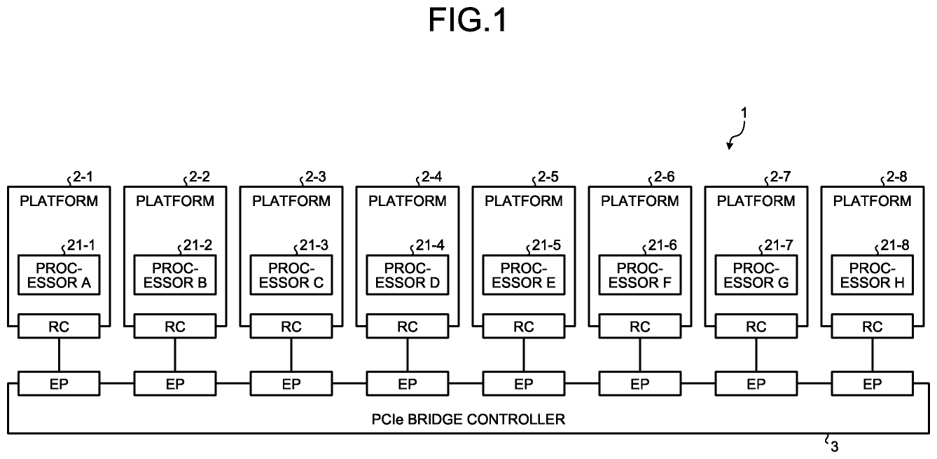

FIG. 1 is a diagram illustrating an example of an overall configuration of the information processing system according to the present embodiment. As illustrated in FIG. 1, an information processing system 1 according to the present embodiment includes a plurality of platforms 2-1 to 2-8 and a relay device 3. Each of the platforms 2-1 to 2-8 is connected to the relay device 3.

In the following description, each of the platforms 2-1 to 2-8 will be referred to as a platform 2 when need not be distinguished from the other platforms, and representing any of the platforms. Although an example will be described herein in which the information processing system 1 includes the eight platforms 2-1 to 2-8, the information processing system 1 is not limited thereto as long as including a plurality of the platforms 2.

Each of the platforms 2-1 to 2-8 is a host personal computer (PC) that serves as a control unit and a graphical user interface (GUI) of the information processing system 1, or is a computing unit that performs, for example, artificial intelligence (AI) inference processing and image processing.

Specifically, the platforms 2-1 to 2-8 include processors 21-1 to 21-8. In the following description, each of the processors 21-1 to 21-8 will be referred to as a processor 21 when need not be distinguished from the other processors and representing any of the processors. The processors 21-1 to 21-8 may be provided by respective different makers (vendors), or provided by the same maker.

For example, it is assumed that the processor 21-1 is provided by Company A, the processor 21-2 by Company B, the processor 21-3 by Company C, the processor 21-4 by Company D, the processor 21-5 by Company E, the processor 21-6 by Company F, the processor 21-7 by Company G, and the processor 21-8 by Company H.

Each of endpoints (EPs) mounted on the relay device 3 may be connected to different one of the platforms 2. Alternatively, one of the platforms 2 may be connected to each of the EPs, and the platform 2 may communicate with the relay device 3 using a plurality of root complexes (RCs).

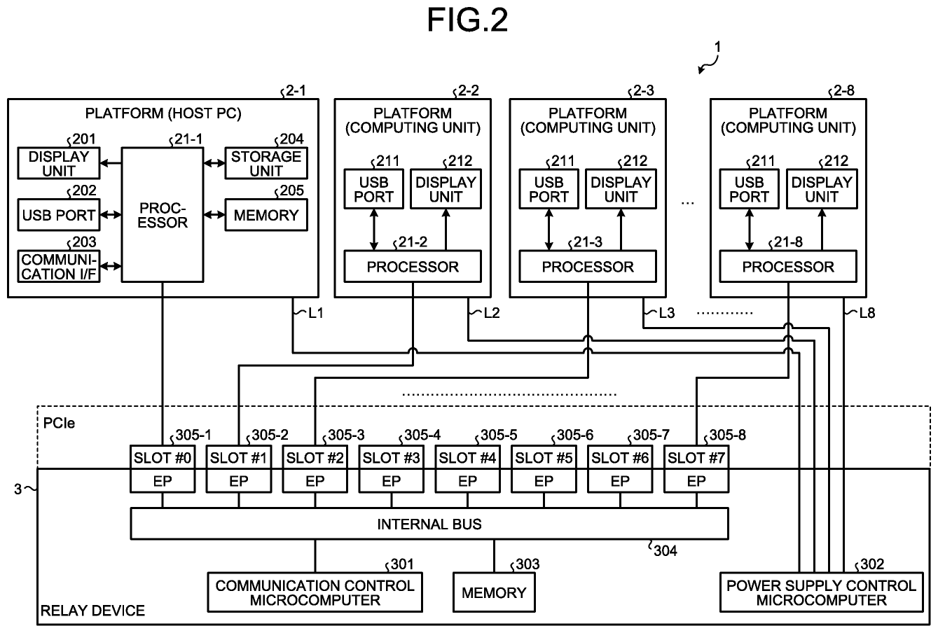

The following describes an example of a hardware configuration of the information processing system 1 according to the present embodiment, with reference to FIG. 2. FIG. 2 is a diagram illustrating the example of the hardware configuration of the information processing system according to the present embodiment. The following describes an example in which the platform 2-1 serves as the host PC, and each of the platforms 2-2 to 2-8 serves as the computing unit that performs, for example, the AI inference processing and the image processing.

First, the following describes the hardware configuration of the platform 2-1 that serves as the host PC.

As illustrated in FIG. 2, the platform 2-1 includes the processor 21-1, a display unit 201, a Universal Serial Bus (USB) port 202, a communication interface (I/F) 203, a storage unit 204, and a memory 205. The display unit 201 is, for example, a liquid crystal display (LCD), and displays various types of information. The USB port 202 is a connector for connecting the platform 2-1 to a peripheral device. The communication I/F 203 enables communication with a network, such as a local area network (LAN), according to a communication standard, such as Ethernet (registered trademark).

The storage unit 204 is a storage device, such as a hard disk drive (HDD), a solid-state drive (SSD), or a storage class memory (SCM), and stores therein various types of data. The memory 205 is, for example, a read-only memory (ROM) or a random access memory (RAM). The ROM stores therein various software programs and data for the software programs. The software programs stored in the ROM are read and executed by the processor 21-1. The RAM serves as a work area when each of the software programs stored in the ROM is executed.

The processor 21-1 is a processor, such as a central processing unit (CPU), a microprocessing unit (MPU), a digital signal processor (DSP), an application specific integrated circuit (ASIC), a programmable logic device (PLD), or a field programmable gate array (FPGA), and controls the entire platform 2-1. The processor 21-1 may be a multi-core processor, or a combination of two or more processors.

Subsequently, the following describes the hardware configuration of the platforms 2-2 to 2-8 each serving as the computing unit that performs, for example, the AI inference processing and the image processing.

As illustrated in FIG. 2, the platform 2-2 includes the processor 21-2, a USB port 211, and a display unit 212. The display unit 212 is, for example, an LCD, and displays various types of information. The USB port 211 is a connector for connecting the platform 2-2 to a peripheral device.

The processor 21-2 is a processor, such as a CPU, an MPU, a DSP, an ASIC, a PLD, or an FPGA, and controls the entire platform 2-2. The processor 21-2 may be a multi-core processor, or a combination of two or more processors. For example, the processor 21-2 may be a combination of a CPU and a graphics processing unit (GPU).

The hardware configuration of the platform 2-2 has been described herein. The same hardware configuration is also employed in each of the other platforms 2-3 to 2-8 serving as the computing unit that performs, for example, the AI inference processing and the image processing.

The following describes the hardware configuration of the relay device 3.

As illustrated, for example, in FIG. 2, the relay device 3 is a relay device that includes the EPs in one chip. As illustrated in FIG. 2, the relay device 3 includes with a communication control microcomputer 301, a power supply control microcomputer 302, a memory 303, and a plurality of slots 305-1 to 305-8. As illustrated in FIG. 2, the communication control microcomputer 301, the memory 303, and the slots 305-1 to 305-8 are connected so as to be capable of communicating with one another through an internal bus 304.

As illustrated in FIG. 2, the power supply control microcomputer 302 is connected through signal lines L1 to L8 to the platforms 2-1 to 2-8 that are connected to the slots 305-1 to 305-8. The signal lines L1 to L8 are signal lines that transmit signals received from the platforms 2-1 to 2-8 to the power supply control microcomputer 302.

The communication control microcomputer 301 and the power supply control microcomputer 302 operate by being supplied with power from respective different power supply units (not illustrated). In the present embodiment, the communication control microcomputer 301 operates by being supplied with the power from the same power supply unit (not illustrated) as that of the platforms 2. In contrast, the power supply control microcomputer 302 operates by being supplied with the power from a power supply unit (not illustrated) different from that of the platforms 2.

Each of the slots 305-1 to 305-8 is an example of an expansion slot (expansion bus) to which a device that meets the PCIe standard is connected. In the present embodiment, the platforms 2-1 to 2-8 are connected to the slots 305-1 to 305-8. In the following description, each of the slots 305-1 to 305-8 will be referred to as a slot 305 when need not be distinguished from the other slots and representing any of the slots.

One of the platforms 2 may be connected to one of the slots 305, or a plurality of the platforms 2 may be connected to one of the slots 305. In addition, assigning a plurality of the slots 305 to one of the platforms 2 allows the platform 2 to communicate using a wide communication band.

The memory 303 is a memory that includes a ROM and a RAM. The ROM of the memory 303 stores therein various software programs including, for example, a software program related to communication control between the platforms 2 connected to the slots 305, and data for the software programs. The software programs stored in the ROM are read and executed by the communication control microcomputer 301. The RAM of the memory 303 serves as a work area when each of the software programs stored in the ROM of the memory 303 is executed.

The platform 2 is provided with a memory area in, for example, a memory 22 corresponding to each of the slots 305. A plurality of storage areas divided into the number of the slots 305 are set in the memory area, and each of the storage areas is associated with any one of the slots 305. The relay device 3 transfers data between the platforms 2 based on an address of the storage area provided for each of the slots 305.

The communication control microcomputer 301 includes a processor, such as a CPU, an MPU, a DSP, an ASIC, a PLD, or an FPGA, and the processor controls the communication between the platforms 2 through the slots 305. The communication control microcomputer 301 may include a combination of a plurality of processors. The communication control microcomputer 301 executes the software program stored in the memory 303 to perform the communication between the platforms 2 connected to the slots 305.

The power supply control microcomputer 302 includes a processor, such as a CPU, an MPU, a DSP, an ASIC, a PLD, or an FPGA, and the processor controls the supply of power to the platforms 2 connected to the slots 305. The processor of the power supply control microcomputer 302 may include a combination of a plurality of processors. The processor of the power supply control microcomputer 302 executes a software program stored in a memory included in the power supply control microcomputer 302 to supply the power from the power supply unit (not illustrated) to the platforms 2 connected to the slots 305.

In the present embodiment, to increase the speed of the communication between the platforms 2, the relay device 3 operates the processor 21 provided on the platform 2 as each of the RCs using the PCIe to transfer the data between the EPs that operate as devices, as illustrated in FIG. 2.

Specifically, in the information processing system 1, the processor 21 of each of the platforms 2 is operated as the RC of the PCIe. The relay device 3 (that is, the slots 305 connected to the respective platforms 2) is operated as the EPs for the processors 21 of the respective platforms 2.

Various known techniques can be used to connect the relay device 3, as the EPs, to the processors 21 of the platforms 2. For example, in order to be connected to the platforms 2, the relay device 3 notifies the platforms 2 of a signal indicating that the relay device 3 serves as the EPs, and, is connected, as the EPs, to the platforms 2.

The relay device 3 transfers the data to the RCs by tunneling the data from endpoint to endpoint (from EP to EP). The communication between the processors 21 of the platforms 2 is logically connected when a transaction of the PCIe has occurred, and the data can be transferred in parallel between the processors 21 unless the data transfer is concentrated on one of the processors 21.

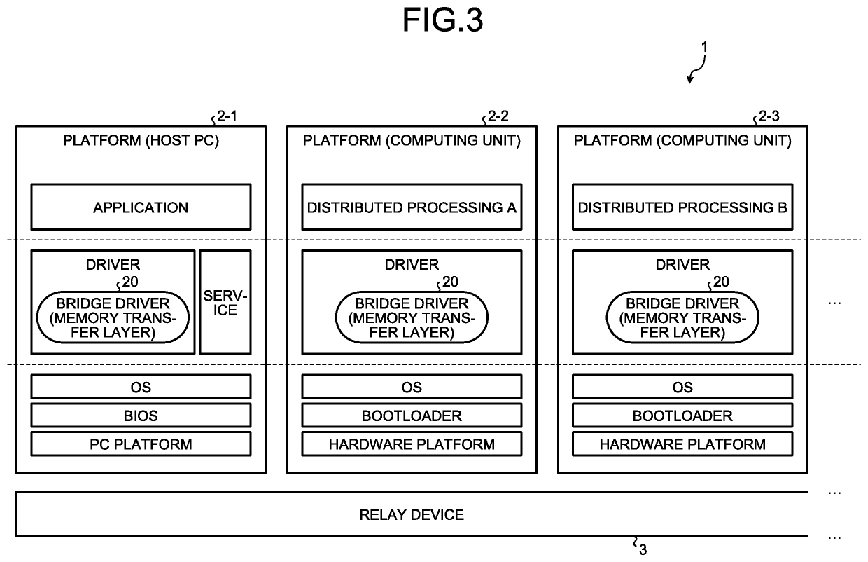

The following describes an example of a software configuration of the platforms 2 of the information processing system 1 according to the present embodiment, with reference to FIG. 3. FIG. 3 is a diagram illustrating the example of the software configuration of the platforms of the information processing system according to the present embodiment.

The platform 2-1 uses, for example, Windows (registered trademark) as an operating system (OS), and executes the various software programs on this OS. The platforms 2-2 and 2-3 use, for example, Linux (registered trademark) as an operating system (OS), and execute the various software programs on this OS.

The platform 2 includes a bridge driver 20, and communicates with the relay device 3 and the other platforms 2 through the bridge driver 20. Each of the platforms 2 includes the processor 21 and the memory. The processor 21 executes, for example, the OS, the various programs, and drivers stored in the memory to perform various functions included in the platform 2.

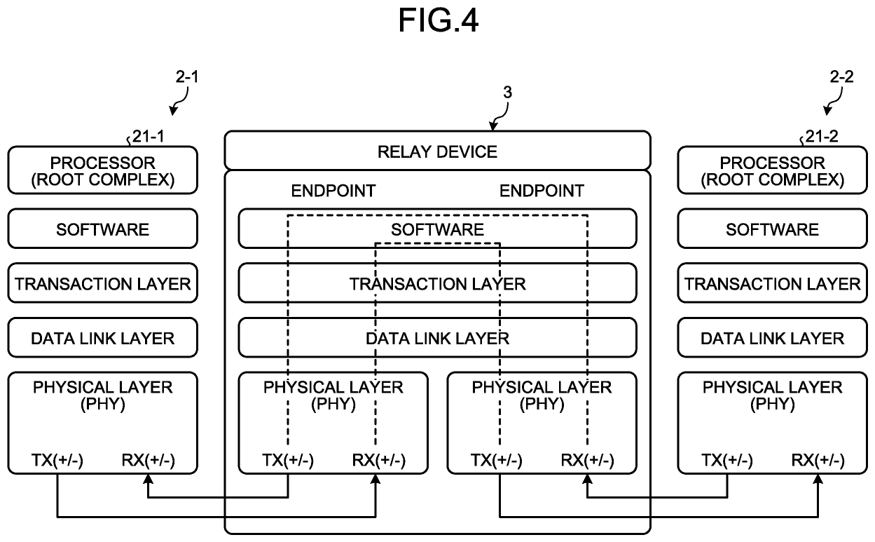

The following describes an example of communication processing between the platforms 2 connected to the relay device 3, with reference to FIG. 4. FIG. 4 is a diagram for explaining the example of the communication processing between the platforms in the information processing system according to the present embodiment. The example will be described herein regarding the communication processing between the processor 21-1 of the platform 2-1 and the processor 21-2 of the platform 2-2.

On the platform 2-1 serving as a transmission source, data generated by the processor 21-1 serving as the RC is sequentially transferred from software through a transaction layer and a data link layer to a physical layer (PHY), and transferred from the physical layer to the physical layer of the relay device 3.

The relay device 3 sequentially transfers the data transferred from the platform 2-1 serving as the transmission source from the physical layer through the data link layer and the transaction layer to the software, and then, transfers, by tunneling, the data to the EP corresponding to the RC of the platform 2-2 serving as a transmission destination. In other words, in the relay device 3, the data is transferred from one of the RCs (processor 21-1) to another of the RCs (processor 21-2) by tunneling the data between the EPs.

On the platform 2-2 serving as the transmission destination, the data transferred from the relay device 3 is sequentially transferred from the physical layer (PHY) through the data link layer and the transaction layer to the software, and then, transferred to the processor 21-2 of the platform 2-2 serving as the transmission destination. In the information processing system 1 of the present embodiment, the communication between the platforms 2 is logically performed when the transaction of the PCIe has occurred.

Unless the data transfer from the platforms 2 is concentrated on the platform 2 connected to one of the slots 305 included in the relay device 3, the data can also be transferred in parallel between any plurality of different sets of the platforms 2. For example, if the processor 21-2 of the platform 2-2 and the processor 21-3 of the platform 2-3 communicate with the processor 21-1 of the platform 2-1, the relay device 3 serially processes the communication performed by the processor 21-2 of the platform 2-2 and the processor 21-3 of the platform 2-3.

Otherwise, if the processors 21 of the different platforms 2 communicate with each other and the communication is not concentrated on the processor 21 of particular one of the platforms 2, the relay device 3 can process the communication between the platforms 2 in parallel.

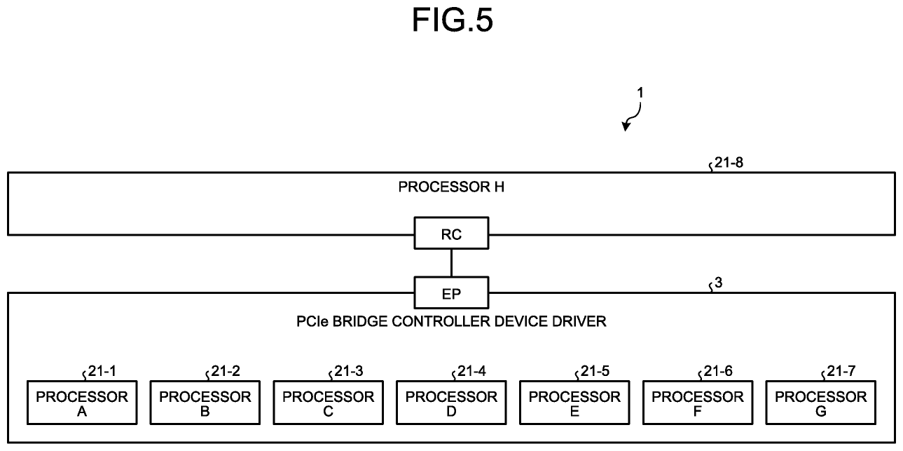

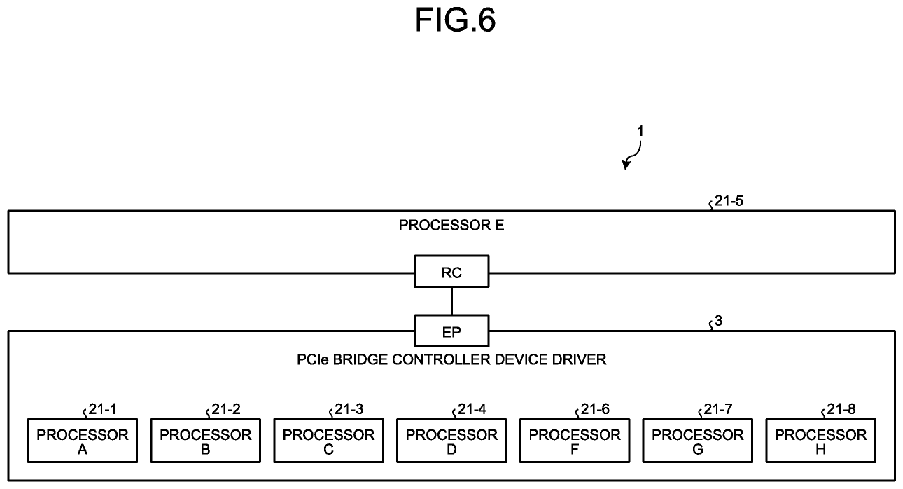

The following describes how the processor 21 of the platform 2 recognizes the processors 21 of the other platforms 2, with reference to FIGS. 5 and 6. FIGS. 5 and 6 are diagrams illustrating examples of how any one of the platforms recognizes the other of the platforms in the information processing system according to the present embodiment.

In a state in which the communication is performed between the processors 21 of the respective platforms 2, the OS (for example, Device Manager of Windows (registered trademark)) executed by each of the processors 21 can recognize only the relay device 3, and therefore, need not directly manage the processors 21 of the other platforms 2 serving as connection destinations. In other words, a device driver of the relay device 3 manages the processors 21 of the platforms 2 connected to the relay device 3.

Accordingly, no device driver needs to be prepared to operate the processors 21 of the platforms 2 serving as the transmission source and the transmission destination, and the communication between the platforms 2 can be performed by only performing the communication processing with the relay device 3 using the device driver of the relay device 3.

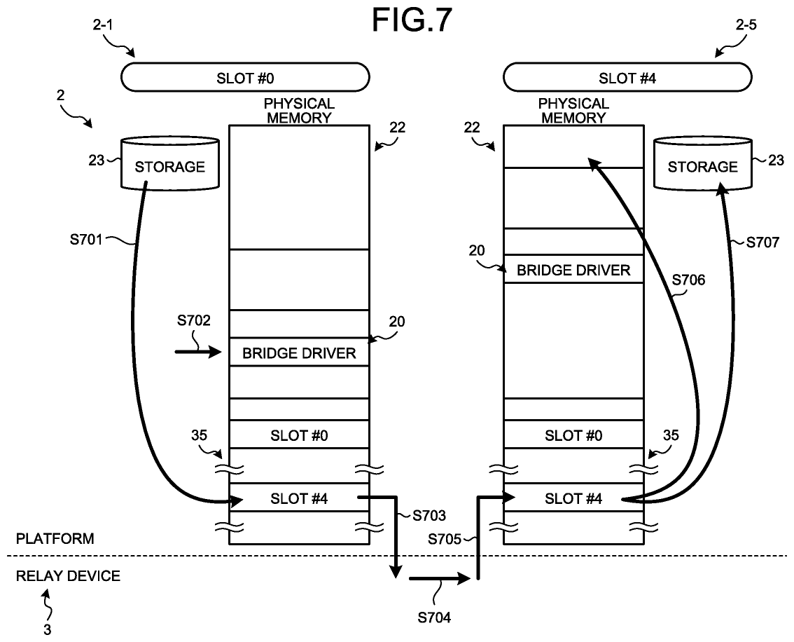

The following describes a method for data transfer between the platforms 2 through the relay device 3 in the information processing system 1, with reference to FIG. 7. FIG. 7 is a diagram for explaining an example of the method for data transfer between the processors through the relay device in the information processing system according to the present embodiment.

In the example illustrated in FIG. 7, a case will be described where data is transferred from the platform 2-1 connected to slot #0 to the platform 2-5 connected to slot #4.

The platform 2-1 serving as the transmission source stores data (hereinafter, called transmission data) to be transmitted by, for example, software from, for example, a storage 23 provided on the platform 2-1 into a memory area 35 of the platform 2-1 (Step S701). The memory area 35 may be a portion of a communication buffer in which data to be transferred is temporarily stored. The memory area 35 is an area provided in the same size as that of, for example, the memory 22 on each of the platforms 2. The memory area 35 is divided according to the number of the slots 305. Divided storage areas of the memory area 35 are each associated with any one of the slots 305. For example, a storage area in the memory area 35 represented as slot #0 is associated with the platform 2-1 connected to slot #0, and a storage area in the memory area 35 represented as slot #4 is associated with the platform 2-5 connected to slot #4. The platform 2-1 stores the transmission data in an area (in this case, slot #4) of the memory area 35 assigned to the slot 305 of the transmission destination.

Based on the storage area in the memory area 35 of the platform 2, the bridge driver 20 acquires or generates slot information indicating the slot 305 of the transmission destination and address information indicating an address in the divided area in the memory area 35 of the transmission destination (Step S702).

At the EP of the transmission source, the bridge driver 20 passes transfer data including the slot information, the address information, and the transmission data to the relay device 3 (Step S703). In this way, the relay device 3 transfers the transfer data to the platform 2-5 serving as the transmission destination by connecting the slot 305 of the transmission source to the slot 305 of the transmission destination in an EP-to-EP manner based on the slot information (Step S704). Based on the slot information and the address information, the bridge driver 20 of the transmission destination stores the transmission data (or the transfer data) in an area having the address indicated by the address information in the storage area corresponding to slot #4 of the memory area 35 of the platform 2 serving as the transmission destination (Step S705).

On the platform 2-5 serving as the transmission destination, for example, a computer program reads the transmission data stored in the memory area 35, and moves the transmission data to the memory (local memory) 22 and the storage 23 (Steps S706 and S707).

In the above-described manner, the data (transfer data) is transferred from the platform 2-1 serving as the transmission source to the platform 2-5 serving as the transmission destination.

In the above-described configuration, the blocks of the platform 2-1 (host PC), the platforms 2-2 to 2-8 (computing units), and the relay device 3 independently operate, and power supply is also independently controlled for each of the blocks. Accordingly, it is difficult to restart the computing units and the relay device 3 even if the host PC is restarted, so that only the host PC restarts. Thus, maintainability of the entire information processing system 1 may be reduced.

Therefore, in the present embodiment, the information processing system 1 is provided with the following functions to allow the computing units and the relay device 3 to restart when the host PC restarts, and thus achieves an improvement in the maintainability of the entire information processing system 1.

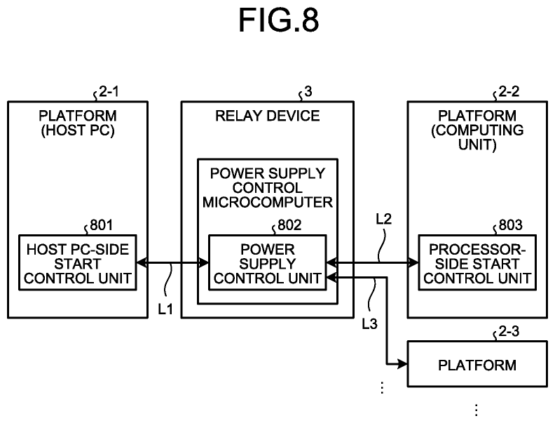

FIG. 8 is a block diagram illustrating an example of a functional configuration of the information processing system 1 according to the present embodiment. A function of the platform 2-1 (host PC) illustrated in FIG. 8 is performed as a result of reading and executing a software program stored in the memory 205 using the processor 21-1. A function of the relay device 3 illustrated in FIG. 8 is performed as a result of reading and executing a software program stored in the memory included in the power supply control microcomputer 302 using the processor included in the power supply control microcomputer 302. Functions of the platforms 2-2 to 2-8 (computing units) illustrated in FIG. 8 are performed as a result of reading and executing software programs stored in the memories included in the platforms 2-2 to 2-8 using the processors 21-2 to 21-8.

First, a functional configuration of the platform 2-1 will be described.

As illustrated in FIG. 8, the platform 2-1 according to the present embodiment includes a host PC-side start control unit 801 as a functional component. The host PC-side start control unit 801 restarts the platform 2-1 when a predetermined condition is met.

The predetermined condition is a condition set in advance. In the present embodiment, the predetermined condition corresponds to a case where operational information for giving an instruction on the restart has been received through an operation unit (not illustrated) provided on the platform 2-1. The predetermined condition may correspond to a case where the restart is requested from the relay device 3 (power supply control microcomputer 302).

In the present embodiment, when the operational information for giving an instruction on the restart has been received, the host PC-side start control unit 801 transmits a shutdown request for requesting shutting down of the platforms 2-2 to 2-8 through the slots 305-1 to 305-8 to the platforms 2-2 to 2-8 before the platform 2-1 is restarted. This configuration can shut down the platforms 2-2 to 2-8 along with the restart of the platform 2-1.

Before the platform 2-1 is restarted, the host PC-side start control unit 801 notifies the power supply control microcomputer 302 through the signal line L1 connected to dedicated terminals, such as general-purpose input/output (GPIO) terminals, that the platform 2-1 is to be restarted. In other words, before the platform 2-1 is shut down along with the restart of the platform 2-1, the host PC-side start control unit 801 notifies the power supply control microcomputer 302 that the platform 2-1 is to be restarted.

Subsequently, a functional configuration of the relay device 3 will be described.

As illustrated in FIG. 8, the power supply control microcomputer 302 of the relay device 3 according to the present embodiment includes a power supply control unit 802 as a functional component. When having been notified from the platform 2-1 that the platform 2-1 is to be restarted, the power supply control unit 802 outputs a start request for requesting starting of the platforms 2-2 to 2-8 to the platforms 2-2 to 2-8.

In the present embodiment, when having been notified through the signal line L1 connected to the dedicated terminals, such as the GPIO terminals, that the platform 2-1 is to be restarted, the power supply control unit 802 outputs the start request to the platforms 2-2 to 2-8 through the signal lines L2 to L8 connected to the dedicated terminals, such as the GPIO terminals.

When having been notified that the platform 2-1 is to be restarted, the power supply control unit 802 performs shutdown processing of the communication control microcomputer 301 through a signal line (not illustrated) connected to the dedicated terminals, such as the GPIO terminals. Then, the power supply control unit 802 restarts the communication control microcomputer 301 through the signal line (not illustrated). This configuration can restart also the communication control microcomputer 301 when the platform 2-1 restarts. Accordingly, the maintainability of the entire information processing system 1 can be improved.

When the communication is not established between the platform 2-1 and the platforms 2-2 to 2-8 through the slots 305-1 to 305-8, or when the platform 2-1 is not able to output the shutdown request to the platforms 2-2 to 2-8 due to, for example, an abnormality in hardware included in the information processing system 1, the power supply control unit 802 outputs the shutdown request to the platforms 2-2 to 2-8 before outputting the start request. This configuration can shut down the platforms 2-2 to 2-8 along with the restart of the platform 2-1 even when the communication is not established between the platform 2-1 and the platforms 2-2 to 2-8.

In addition, when a watchdog timer included in the communication control microcomputer 301 has detected an abnormality in the communication control microcomputer 301 and the shutdown processing of the communication control microcomputer 301 has been performed, the power supply control unit 802 requests the platform 2-1 to restart through the signal line L1, and notifies the platforms 2-2 to 2-8 of the shutdown request. This configuration can shut down the platforms 2-2 to 2-8 along with the restart of the platform 2-1 even when the communication cannot be performed between the platform 2-1 and the platforms 2-2 to 2-8 due to the abnormality in the communication control microcomputer 301.

Subsequently, a functional configuration of the platform 2-2 will be described. Although the following describes the functional configuration of the platform 2-2, each of the platforms 2-3 to 2-8 also has the same functional configuration.

In addition, as illustrated in FIG. 8, the platform 2-2 according to the present embodiment includes a processor-side start control unit 803 as a functional component. The processor-side start control unit 803 performs the shutdown processing of the processor 21-2 when a shutdown request has been received from the platform 2-1 through the slots 305-1 and 305-2.

In the present embodiment, the processor-side start control unit 803 performs the shutdown processing according to the shutdown request received from the platform 2-1 through the slots 305-1 and 305-2. However, the present disclosure is not limited thereto. For example, the processor-side start control unit 803 also performs the shutdown processing in the same way when a shutdown request has been received from the power supply control microcomputer 302 of the relay device 3 through the signal line L2.

When a start request has been received from the relay device 3 through the signal line L2, the processor-side start control unit 803 performs start processing for starting the platform 2-2 after performing the shutdown processing. This configuration can restart also the platform 2-2 when the platform 2-1 has restarted. Accordingly, the maintainability of the entire information processing system 1 can be improved.

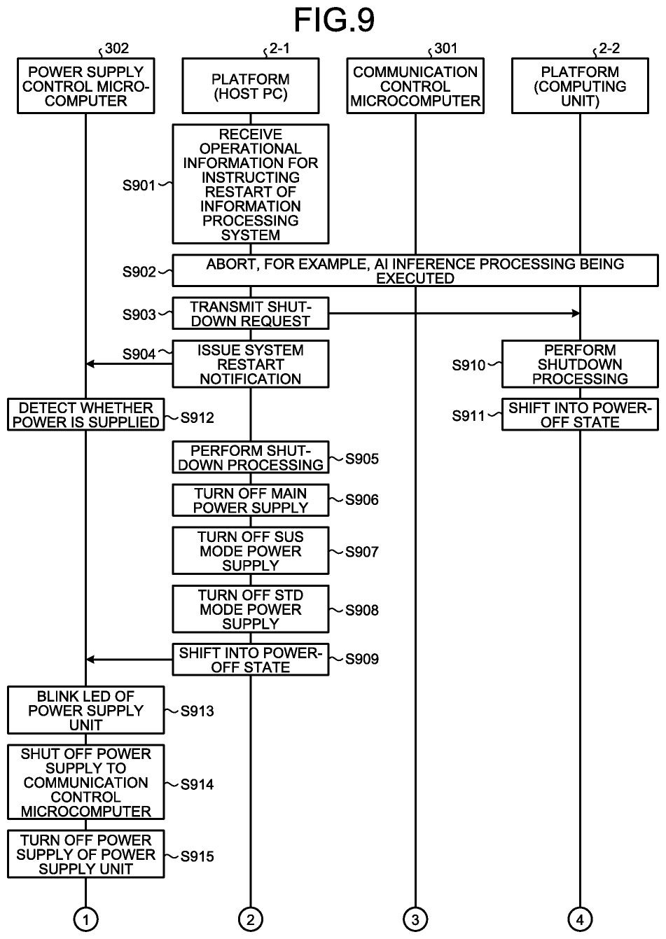

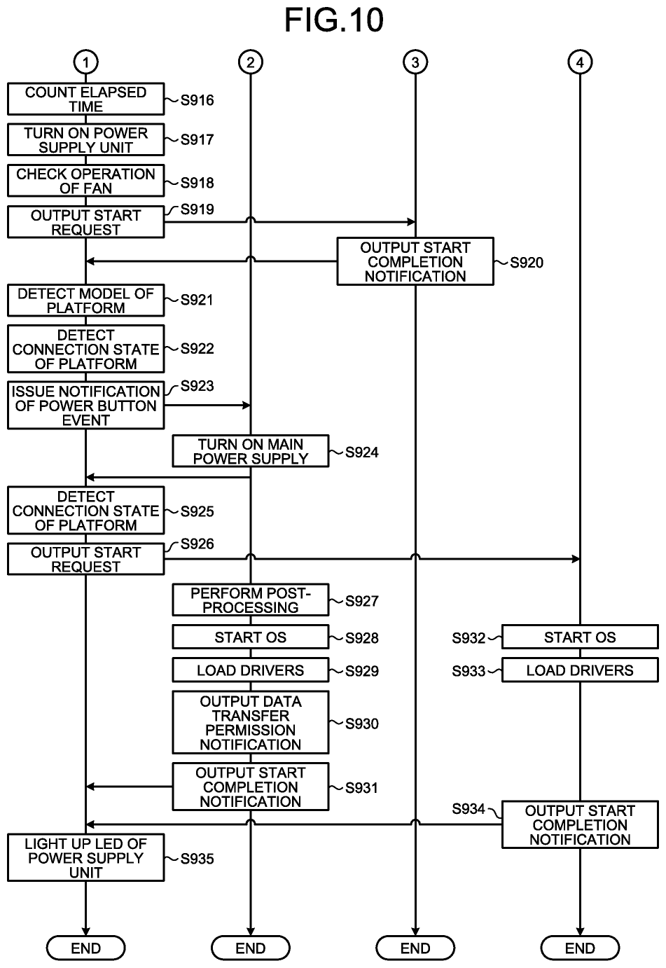

The following describes an example of a flow of the restart processing in the information processing system 1 according to the present embodiment, using FIGS. 9 and 10. FIGS. 9 and 10 are sequence diagrams illustrating an example of a flow of restart processing in the information processing system according to the present embodiment.

The host PC-side start control unit 801 of the platform 2-1 (host PC) waits until the operational information for giving an instruction on the restart is received through the operation unit provided on the platform 2-1. After the operational information for giving an instruction on the restart of the platform 2-1 is received (Step S901), the host PC-side start control unit 801 aborts, for example, the AI inference processing and the image processing being executed on the platforms 2-2 to 2-8 (Step S902). The host PC-side start control unit 801 then waits for completion of the data transfer between the platform 2-1 and the platforms 2-2 to 2-8.

Subsequently, after the data transfer between the platform 2-1 and the platforms 2-2 to 2-8 is completed, the host PC-side start control unit 801 transmits the shutdown request through the slots 305-1 to 305-8 to the platforms 2-2 to 2-8 (Step S903). In addition, the host PC-side start control unit 801 notifies the power supply control microcomputer 302 of a system restart notification indicating the execution of restarting the platform 2-1 to the power supply control microcomputer 302 through the signal line L1 (Step S904).

After outputting the system restart notification to the power supply control microcomputer 302, the host PC-side start control unit 801 of the platform 2-1 performs the shutdown processing of the platform 2-1 (Step S905). In addition, the host PC-side start control unit 801 turns off a main power supply, a suspend (SUS) mode power supply, and a suspend-to-disk (STD) mode power supply (Steps S906 to S908). Then, the host PC-side start control unit 801 shifts the platform 2-1 into a power-off state serving as a state in which no power is consumed, and notifies the power supply control microcomputer 302 that the platform 2-1 has been shifted into the power-off state through the signal line L1 (Step S909).

Subsequently, after the shutdown request is received from the platform 2-1, the processor-side start control units 803 of the platforms 2-2 to 2-8 perform the shutdown processing of the platforms 2-2 to 2-8 (Step S910). In addition, after performing the shutdown processing of the platforms 2-2 to 2-8, the processor-side start control units 803 shift the platforms 2-2 to 2-8 into the power-off state serving as the state in which no power is consumed (Step S911).

After the system restart notification is received from the platform 2-1, the power supply control unit 802 of the relay device 3 detects whether the power is supplied from the external power supply unit (not illustrated) to the platforms 2-1 to 2-8 (Step S912). If the power supply control unit 802 determines that the power is not supplied from the external power supply unit (not illustrated) to the platforms 2-1 to 2-8 due to the shutdown processing along with the restart of the platform 2-1, the power supply control unit 802 determines that the shutdown processing of the platforms 2-1 to 2-8 has been completed, and, for example, blinks a light-emitting diode (LED) included in the external power supply unit (not illustrated) (Step S913). This operation notifies an operator that the power supply to the platform 2-1 has been shut off.

After the shutdown processing of the platforms 2-1 to 2-8 is performed along with the restart of the platform 2-1, the power supply control unit 802 of the relay device 3 causes the communication control microcomputer 301 to perform the shutdown processing, and shuts off the power supply from the external power supply unit (not illustrated) to the communication control microcomputer 301 (Step S914). In addition, the power supply control unit 802 turns off the power supply of the external power supply unit (not illustrated) that supplies the power to the platforms 2-1 to 2-8 and the communication control microcomputer 301 (Step S915).

The power supply control unit 802 of the relay device 3 counts an elapsed time from when the shutdown processing of the entire information processing system 1 is completed (Step S916). If the counted elapsed time has reached a preset time (for example, 10 s), the power supply control unit 802 turns on the external power supply unit (not illustrated) (Step S917). In addition, the power supply control unit 802 detects whether a fan included in the relay device 3 operates normally (Step S918).

After the power supply of the external power supply unit is turned on and the supply of power from the external power supply unit is resumed, the power supply control unit 802 of the relay device 3 outputs a start request to the communication control microcomputer 301 to start the communication control microcomputer 301 (Step S919).

Then, after a start completion notification notifying that the start has been completed is received from the communication control microcomputer 301 (Step S920), the power supply control unit 802 detects a model of the platform 2-1 to be connected to the slot 305-1 and a connection state of the platform 2-1 to the slot 305-1 (Steps S921 and S922). Examples of the connection state of the platform 2-1 include whether the platform 2-1 is connected to the slot 305-1, whether the platform 2-1 is supplied with the power, and whether the OS of the platform 2-1 is operating normally.

In addition, if no abnormality is detected in the connection state of the platform 2-1, the power supply control unit 802 notifies the platform 2-1 of a power button event through the signal line L1 (Step S923).

After being notified of the power button event from the power supply control microcomputer 302, the host PC-side start control unit 801 of the platform 2-1 turns on the main power supply (Step S924). After the main power supply is turned on, the power supply control unit 802 of the relay device 3 detects connection states of the platforms 2-2 to 2-8 to the slots 305-2 to 305-8 (Step S925). Examples of the connection states of the platforms 2-2 to 2-8 include whether the platforms 2-2 to 2-8 are connected to the slots 305-2 to 305-8, whether the platforms 2-2 to 2-8 are supplied with the power, and whether the OS of each of the platforms 2-2 to 2-8 is operating normally.

If no abnormality is detected in the connection states of the platforms 2-2 to 2-8, the power supply control unit 802 outputs the start request to the platforms 2-2 to 2-8 through the signal lines L2 to L8 (Step S926).

The host PC-side start control unit 801 starts the start processing of the platform 2-1 before starting the platforms 2-2 to 2-8. Subsequently, the host PC-side start control unit 801 performs post-processing to determine whether a Basic Input/Output System (BIOS) of the platform 2-1 has started (Step S927).

If the BIOS is determined as having been started, the host PC-side start control unit 801 starts the OS of the platform 2-1, and loads the various drivers including the bridge driver 20 (Steps S928 and S929). The host PC-side start control unit 801 outputs a data transfer permission notification to permit the data transfer between the platform 2-1 and the platforms 2-2 to 2-8 to the communication control microcomputer 301 (Step S930).

Finally, the host PC-side start control unit 801 outputs a start completion notification notifying that the start processing of the platform 2-1 has been completed to the power supply control microcomputer 302 through the signal line L1 (Step S931).

After the start request is received from the power supply control microcomputer 302 (Step S926), the processor-side start control units 803 of the platforms 2-2 to 2-8 start the OS's of the platforms 2-2 to 2-8, and load the various drivers including the bridge driver 20 (Steps S932 and S933). Then, the processor-side start control unit 803 outputs a start completion notification notifying that the start processing of the platform 2-2 has been completed to the power supply control microcomputer 302 through the signal line L2 (Step S934).

After the start completion notifications are received from the platforms 2-1 to 2-8, the power supply control unit 802 of the relay device 3, for example, lights up the LED included in the external power supply unit (not illustrated) (Step S935). This operation notifies an operator that the entire information processing system 1 has been completely restarted.

As described above, with the information processing system 1 according to the present embodiment, when the platform 2-1 has restarted, the platforms 2-2 to 2-8 and the communication control microcomputer 301 can also restart. Accordingly, the maintainability of the entire information processing system 1 can be improved.

With the information processing system 1 according to the present embodiment, the predetermined condition corresponds to the case where the operational information for giving an instruction on the restart has been received from the operation unit provided on the platform 2-1, and, when the operational information has been received, the host PC-side start control unit notifies the platforms 2-2 to 2-8 of the shutdown request through the slots 305 before the platform 2-1 is restarted. This configuration can shut down the platforms 2-2 to 2-8 along with the restart of the platform 2-1.

With the information processing system 1 according to the present embodiment, when the communication is not established between the platform 2-1 and the platforms 2-2 to 2-8 through the slots 305, the power supply control microcomputer 302 notifies the platforms 2-2 to 2-8 of the shutdown request before outputting the start request. This configuration can shut down the platforms 2-2 to 2-8 along with the restart of the platform 2-1 even when the communication is not established between the platform 2-1 and the platforms 2-2 to 2-8.

With the information processing system 1 according to the present embodiment, the predetermined condition corresponds to the case where the restart is requested from the power supply control microcomputer 302, and the communication control microcomputer 301 is provided with the watchdog timer, and, when the watchdog timer has detected an abnormality in the communication control microcomputer 301 and the shutdown processing of the communication control microcomputer 301 has been performed, the power supply control microcomputer 302 requests the platform 2-1 to restart, and notifies the platforms 2-2 to 2-8 of the shutdown request. This configuration can shut down the platforms 2-2 to 2-8 along with the restart of the platform 2-1 even when the communication is not established between the platform 2-1 and the platforms 2-2 to 2-8 due to the abnormality in the communication control microcomputer 301.

Although the embodiment above has been described by exemplifying the PCIe as an input-output (I/O) interface for each component, the I/O interface is not limited to the PCIe. For example, the I/O interface for each component only needs to be a technique that allows data transfer between a device (peripheral controller) and processors through a data transfer bus. The data transfer bus may be a general-purpose bus that can transfer data at high speed in a local environment (for example, one system or one device) provided, for example, in one housing. The I/O interface may be either a parallel interface or a serial interface.

The I/O interface only needs to have a configuration allowing a point-to-point connection and allowing serial transfer of the data on a packet-by-packet basis. In the case of the serial transfer, the I/O interface may have a plurality of lanes. The I/O interface may have a layer structure including a transaction layer that generates and decodes packets, a data link layer that performs, for example, error detection, and a physical layer that performs serial/parallel conversion. The I/O interface may include, for example, a root complex disposed at the hierarchically top level and including one or a plurality of ports, an endpoint serving as an I/O device, switches for increasing the ports, and a bridge that converts protocols. The I/O interface may multiplex the data to be transmitted with clock signals using a multiplexer, and transmit the result. In this case, a receiving side may use a demultiplexer to separate the data from the clock signals.

According to one aspect of this disclosure, when the first platform has restarted, the second platform and the communication control microcomputer can also restart. Accordingly, the maintainability of the entire information processing system can be improved.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A system comprising:
a first platform;
a second platform; and
a relay device comprising an expansion bus connected to the first platform and the second platform, wherein
the first platform includes a first processor that, after a predetermined condition is met, restarts the first platform, and, before the first platform is restarted, notifies the relay device that the first platform is to be restarted,
the relay device includes:
a communication control microcomputer that controls communication between the first platform and the second platform through the expansion bus; and
a power supply control microcomputer that outputs, after having been notified that the first platform is to be restarted, a start request to turn on a power supply of the second platform to the second platform, and starts the communication control microcomputer after the communication control microcomputer is shut down, and
the second platform includes a second processor that performs shutdown processing to turn off the power supply of the second platform in response to reception of a shutdown request for requesting shutting down of the second platform, and performs start processing for starting the second platform in response to reception of the start request from the relay device.

2. The system according to claim 1, wherein
the predetermined condition corresponds to a case where operational information for giving an instruction on the restart has been received from an operation unit operatively coupled to the first platform, and
in response to reception of the operational information, the first processor notifies the second platform of the shutdown request through the expansion bus before the first platform is restarted.

3. The system according to claim 1, wherein the power supply control microcomputer notifies the second platform of the shutdown request before outputting the start request when the communication is impossible between the first platform and the second platform through the expansion bus.

4. The system according to claim 1, wherein
the predetermined condition corresponds to a case where the restart is requested from the power supply control microcomputer,
the communication control microcomputer includes a watchdog timer, and
after the watchdog timer has detected an abnormality in the communication control microcomputer and the communication control microcomputer has been shut down, the power supply control microcomputer requests the first platform to restart and notifies the second platform of the shutdown request.
